(19) United States
(12) Patent Application Publication
(10) Pub. No.: US 2012/0117608 A1
(43) Pub. Date: May 10, 2012

(54) CERTIFICATE POLICY MANAGEMENT TOOL

(75) Inventors: Anthony R. Metke, Naperville, IL (US); Erwin Himawan, Chicago, IL (US); Shanthi E. Thomas, Carpentersville, IL (US)

(73) Assignee: MOTOROLA, INC., Schaumburg, IL (US)

(21) Appl. No.: 12/942,374

(22) Filed: Nov. 9, 2010

(51) Int. Cl. H04L 29/06

(52) U.S. Cl. 726/1

(57) ABSTRACT

A certificate policy management tool (100) is provided which targets the automated creation of customized certificate policies and the management of these policies within a public key infrastructure (PKI). A certificate policy parser 108, a certificate policy creation engine (110), a policy query engine (112), and an audit engine (114) interoperate to automate certificate policy creation, interpretation, and enforcement.

### FIELD OF THE DISCLOSURE

The present disclosure relates generally to communication systems and more particularly to enabling public key infrastructure (PKI) within a public safety organization.

### BACKGROUND

A typical public key infrastructure (PKI) scheme utilizes infrastructure-based components and methods, such as a Certification Authority (CA), a Registration Authority (RA) and a certificate repository, along with procedures, policies and personnel in various roles. PKI is a framework for certifying or binding the identity of an individual, a device, and/or an organization with a public key in a digital certificate.

PKIs have been slow to develop mainly due to the complexities involved in setting up and maintaining the infrastructure. The operation and management of PKIs involves for example, defining effective certificate policies, ensuring adherence to these policies and providing certificate revocation lists, training personnel to understand PKI, provisioning PKI materials such as certificates, client policies, and the like, all of which are complex and costly.

While there has been commercial deployment of PKI within e-commerce and Web-based applications, this type of deployment utilizes PKI in its simplest form wherein all certificate subjects are effectively considered to be within the same class of applications and in the same community of users with a common set of security requirements. However, this commercial model is not sufficient to support the Public Safety use cases where there is need for a diverse set of controls and constraints on the community of users who have varying security requirements.

Federal agencies, such as the United States Department of Defense and others, have been able to deploy PKI models supporting a more diverse set of use cases with varying security requirements. However, this has been possible only by investing a significant amount of resources that include people and capital. This extent of resources is not available to all public safety agencies such as those operating at the local or county level.

Some public safety agencies have adopted symmetric-key based security approaches only to be burdened by manual provisioning of pre-shared keys across several devices. Unfortunately, the use of symmetric-key based approaches has also led to weak security practices such as using non-unique keys and not renewing these pre-shared keys periodically.

Accordingly, there is a need for a PKI certificate policy tool for use in public safety applications.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a certificate policy management tool in accordance with various embodiments of the invention.

FIG. 2 is an example of tables depicting how standard certificate policies and certificate policy creation rules can be represented in the PCRD of FIG. 1 in accordance with various embodiments of the invention.

FIG. 3 is a method 300 for managing customized certificate policies within a public key infrastructure (PKI) in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Briefly, in accordance with various embodiments to be described herein, there is provided a certificate policy management tool which targets the automated creation of customized certificate policies and the management of these customized certificate policies within a public key infrastructure (PKI). The policy management tool enables a PKI administrator to define policies by choosing from options specified in standard policies. Policies are managed and enforced to remain in compliance within organization-specific requirements. Public safety organizations such as law enforcement, fire, and search & rescue are examples of public safety organizations which have organization-specific requirements.

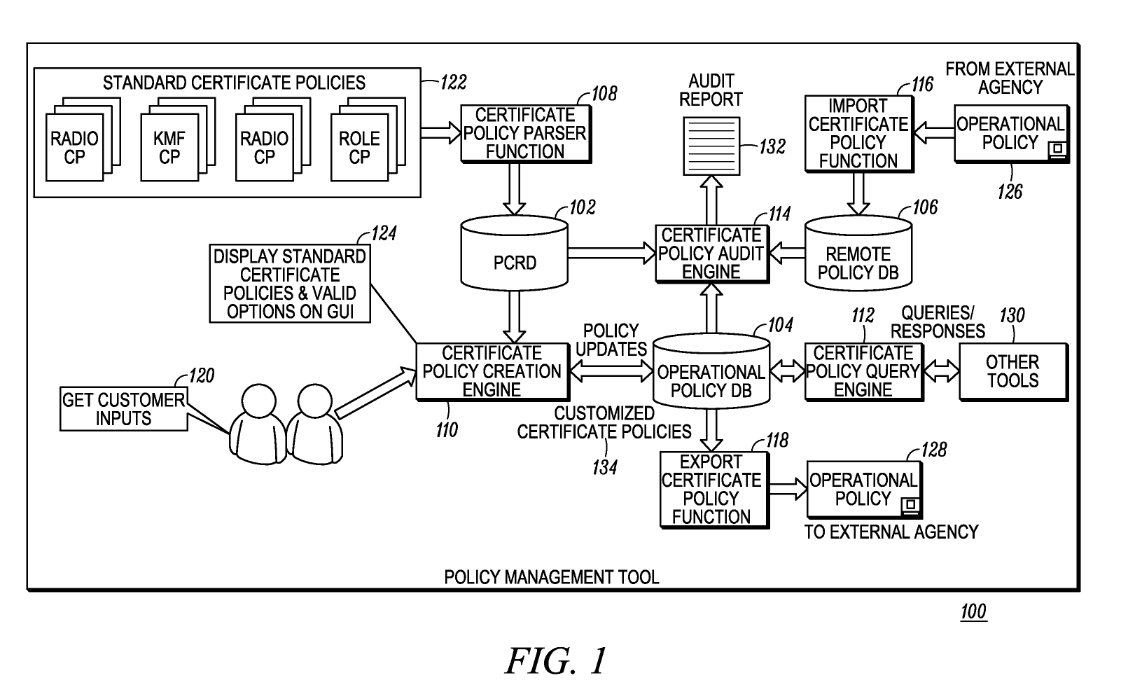

FIG. 1 is a block diagram of a certificate policy management tool 100 providing a plurality of smart public key infrastructure (PKI) management components formed and operating in accordance with various embodiments of the invention. To facilitate the description, certificate policy management tool 100 is shown as comprising a plurality of separate databases, engines and functions however, it is understood that these components can all be incorporated into a single processor/controller/database or various combinations of processors/controllers/databases.

Certificate policy management tool 100 comprises a policy creation rule database (PCRD) 102, an operational policy database 104, a remote policy database 106, a certificate policy parser function 108, a certificate policy creation engine 110, a certificate policy query engine 112, a certificate policy audit engine 114, an import certificate policy function 116, and an export certificate policy function 118. Certificate policy management tool 100 may receive information from and provide information to, users 120 via a user interface 124. In response to audits and queries, the certificate policy management tool 100 may receive information from and provide information to external organizations 126, 128 and other tools 130.

The PCRD 102 and certificate policy creation engine 110 are controlled by at least one processor providing executable code, and an iterative process is used in the creation of the customized certificate policies 134. The certificate policy creation engine 110 reads a current set of certificate policy options from the certificate policy creation rules database (PCRD) 102 and provides a current set of certificate options to a user. The certificate policy creation engine 110 accepts user input 120 received in response to the current set of options. The user input 120 is mapped to appropriate certificate policy options and the mapped certificate policy options are stored in operational policy database 104. A next set of certificate options is formed based on the user input as well as constraints defined in the PCRD 102. This process is iteratively repeated until an acceptable set of options are formed to generate a customized certificate policy 134.

In accordance with the various embodiments, the certificate policy parser 108, the certificate policy creation engine 110, the certificate policy query engine 112, and the certificate policy audit engine 114 interoperate to automate certificate policy creation, interpretation, assessment, and enforcement. The standard certificate policies 122 are parsed at policy parser 108 and stored within PCRD 102. In operation, the certificate policy parser 108 reads in and parses standard certificate policies 122 containing standard public safety options and constraints. The certificate policy creation engine 110 determines allowable combinations of certificate policy options based on the user inputs, and constraints contained within the standard certificate policy. In accordance with the various embodiments, the certificate policy creation engine 110 displays user selectable certificate policy options 124 with which to create organization-specific operational certificate policies, also referred to as customized certificate policies 134. The customized certificate policies 134 are stored within operational certificate policy database 104.

Once the customized certificate policies 134 are created and stored, the overall management of the customized certificate policies is controlled by the remainder of the components within certificate policy management tool 100. As part of the certificate management, the policy query engine 112 generates a PKI Management rule set. This can be triggered by either queries from other tools 130 or changes in the customized certificate policy. The certificate policy query engine generates an updated PKI management rule set based on data obtained from the customized certificate policies stored in the operational certificate policy database 104. In responding to queries from other PKI Management tools, the certificate policy query engine maps these PKI Management rule set into an application specific message. Also, if requested by other tools 130, the operational policy database 104 may export the customized certificate policies 134 via export certificate policy function 118 to the external organizations operational policies 128. In accordance with the various embodiments, external operational policies 126 may be imported through the import certificate policy function 116 and stored within remote policy database 106.

The audit engine 114 compares first and second separate sets of certificate policies, and generates a report identifying differences and incompatibilities. The audit engine 114 verifies whether the two sets of certificate policies conform to each other. Policies are said to be conforming if they are deemed to meet or exceed a common set of requirements. Additionally, the audit engine 114 generates rules that map the policies of the first certificate policy set to conforming policies of the second certificate policy set. To accomplish the auditing task, the audit engine 114 compares the external organization operational policies 126 to the parsed standard certificate policies stored within PCRD 102 and/or to the customized certificate policies stored in operational policy database 104. The audit engine 114 generates an audit report 132 indicating differences and incompatibilities amongst the external organization operational policies 126, the parsed standard certificate policies from PCRD 102 and the customized certificate policies 134 from operational policy database 104. The audit engine 114 can further determine the appropriate policy mapping for interoperation of PKI with the external organizations 126.

Policies are typically identified by a Policy ID, also known as an Object ID (OID). It is customary to represent an OID as a series of numbers separated by the period character, “.” For example “1.2.3”, and “1.3572.194.0” are both valid OID formats. In one embodiment the audit engine 114 would compare the OID of an external policy 126 to the OIDs associated with the standard certificate policies stored within PCRD 102 and/or the customized certificate policies stored in operational policy database 104 (a.k.a. Local Policies). If there is a match between the OID of the external policy and the OID of one of the Local Policies the audit engine 114 will compare individual policy options in the external policy and the matching local policy and attempt to confirm that each option is conforming In some cases, a set of two or more options in one policy may be determined to be conforming to one option of another policy. This is because it may take two or more options to meet the same requirements that are met by one option in another policy.

An Option may represent a security requirement, a method of meeting a security requirement, or a set of one or more security operations. Examples of Options may include; methods to identify a certificate subject, methods to determine the applicability of a given certificate type to a certificate subject, methods of protecting private or secret information (including keys), methods of providing physical protection of security facilities, methods of secure logging of certificate lifecycle events, methods of approving certificate revocation requests, methods of approving certificate signing requests. These are but a few of the many possible types of options that may be in a certificate policy.

In some cases Policy A may adhere to the requirements of Policy B, but Policy B may not adhere to the requirements of Policy A. This would be true when Policy A has higher (or a superset of requirements) to Policy B. In this case Policy A is said to conform to Policy B, but Policy B does not conform to Policy A. In such a case Policy B is said to be subordinate to Policy A. Another policy, Policy C, may be found to conform to Policy B but not to Policy A. Policy C may then be mapped to Policy B but not Policy A.

In one embodiment, when the audit engine 114 determines that an external policy with a given OID is not conforming with any standard certificate policies and/or to any customized certificate policies with the same OID, the audit engine 114 may map the external policy to local certificate for which the external policy does conform. One result of the policy mapping function is a declaration by the audit engine 114 that an external policy with OID X is treated locally as the Local Policy with OID Y.

For efficiency purposes, the audit engine 114 can be enabled to easily determine which policies are likely subordinate to others, so that the audit engine 114 can first compare policies with equivalent OID followed by policies that are subordinate, before determining whether it is necessary to compare other policies. For example a policy identified with the OID 1.2.3 may be known to be subordinate to 1.2.4 or 1.2.3.1.

When policy mapping occurs, the audit engine 114 may map the external policy to a subset of conformant local policies, referred to here as named policies. In such cases, the external policy also conforms to all policies subordinate to the named policy.

A summary of the certificate policy management tool components is provided as follows:
Policy creation rule database (PCRD) 102
The PCRD 102 holds the certificate policy information as parsed by certificate policy parser 108 from the standard certificate policies 122. The PCRD 102 contains metadata that is used to relate disparate sections in the standard certificate policies 122 that affect each other. The PCRD schema follows that of the operational policy database 104.
Operational Policy Database
The operational policy database stores the customized certificate policies 134 created by certificate policy creation engine 110 based on user input 120 applied to the standard certificate policies and options 124.
   Remote Policy Database
The remote policy database holds certificate polices from external organization that are used for policy mapping and for audit functions.
   Certificate Policy Parser
The certificate policy parser function reads in and parses the standard certificate policies 122. The standard certificate policies 122 follow a template specified in Request For Comments (RFC) 3647 and are represented in an easily parsable format such as Extensible Markup Language (XML) or Abstract Syntax Notation One (ASN.1) to name a few. Only the template is dictated by the RFC. The standard certificate policies 122, as represented by a set of certificate policy creation rule text files, contain standard public safety options and the constraints dictating the allowable combination of options and policies. The standard certificate policy parser 108 writes the parsed standard certificate policies into PCRD 102.
   Certificate Policy Creation Engine
The certificate policy creation engine 110 is the heart of the certificate policy management tool 100 and implements most of the compatibility checks and guidance. The certificate policy creation engine 110 reads from the PCRD 102 and displays the various options and the certificate policies via user interface 124. The user 120 can select the options and certificate policies best suited to the specific desired organization as guided by the tool. The resulting organization-specific operational certificate policies 134 are stored in the operational policy database 104. Note that the different databases shown in the FIG. 1 are just logical separations; the different databases may all be embodied in one physical database, if desired.
   Certificate Policy Query Engine
The certificate policy query engine 112 abstracts the operational policy database schema from the rest of the tools in the smart PKI Management tool suite. The certificate policy query engine handles queries from the other tools 130. The other tools may include for example, a PKI configuration tool, a policy control object generation tool or a certificate lifecycle management tool (CLM). The certificate policy query engine 112 converts application level queries from these tools into a set of database-specific queries and generates a PKI Management rule set or policy control object from data obtained from the operational policy database 104.
   Certificate Policy Audit Engine
The certificate policy audit engine 114 compares operational policies of external organizations 126 and compares them with either the PCRD 102 or the customized certificate policies and generates a report highlighting the differences and incompatibilities. The certificate policy audit engine serves as a background or on-demand internal auditor that verifies whether the customized certificate policy conforms to the standard certificate policy. Any discrepancies detected by the certificate policy audit engine 114 are flagged as alerts to a policy authority. The certificate policy audit engine component can also be used to determine appropriate policy mapping to be used when inter-operating with external organizations 126, 128.
   Import Policy
The import policy function 116 reads a remote organization's operational policy 126 and imports it into the remote policy database 106 for use by the audit engine 104.
   Export policy
The export policy function 118 reads the operational policy database for the customized certificate policy and converts the customized certificate policy into an appropriate format for export.

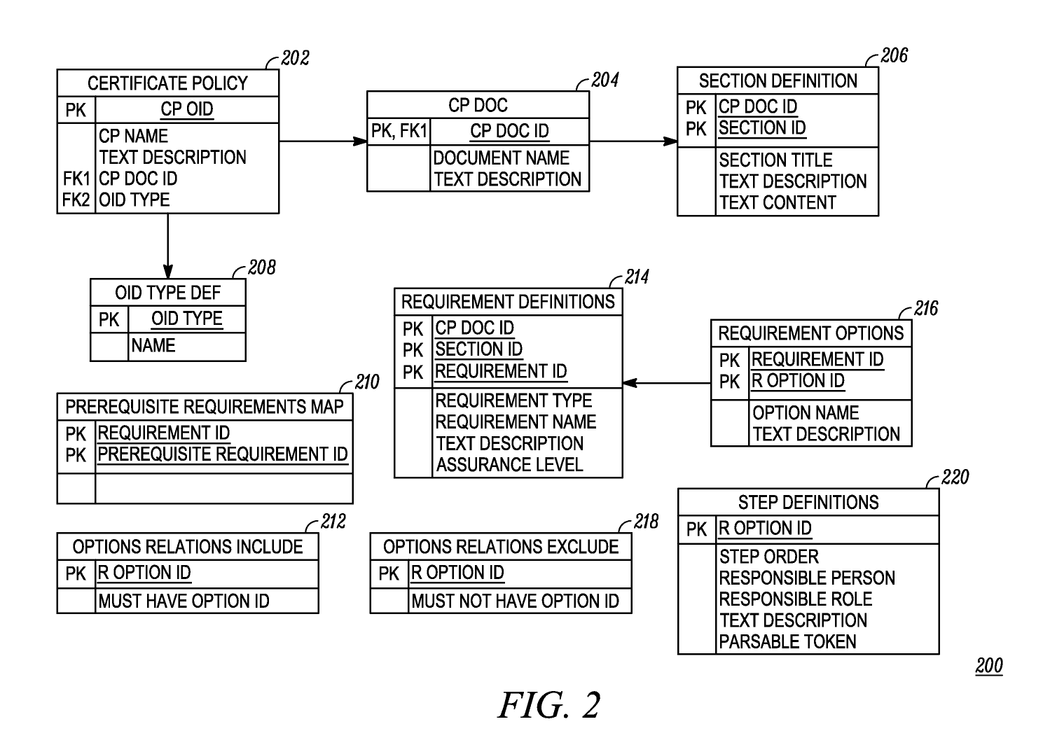

Referring to FIG. 2, there is shown a set of tables 200 which depict how the parsed standard certificate policies could be stored in the PCRD 102. The PCRD 102 contains not only the parsed standard policy certificates but options and constraints needed to create an organization-specific operational policy certificate. These tables are representation of information stored in a standard relational database. In this example, table 202 represents the parsed certificate policy containing, for example the certificate policy name, identification, and type. Table 204 contains data that associates a certificate policy document identification to a particular certificate policy document. A certificate policy document contains requirements for issuing a certificate associated with a specific policy. A certificate policy is a named set of rules that indicate the applicability of certificate to a particular community and/or class of applications with common security requirements. The certificate policy document typically follows a template specified in RFC 3647. RFC3647 provides a framework to assist writers of certificate policies or certification practice statements, for participants within public key infrastructures, such as certification authorities, policy authorities, and communities of interest that wish to rely on certificates.

Table 206 further associates a title, a description, and the policy content within the specified section in the specified certificate policy document. Table 208 contains the certificate policy Object ID and its associated policy name. The Prerequisite Requirement MAP Table 210 depicts a relational database table that associates with each requirements ID, one or more prerequisite requirement IDs. For example, requirement 9 may be found twice in the table, once paired with prerequisite requirement 2 and once with prerequisite requirement 7, indicating that requirement 9 can only be selected if both requirements 2 and 7 have already been selected. The Requirement Definitions Table 214 associates a requirement type, a requirement name, a text description and an assurance level with the combination of certificate policy document ID, Section ID, and Requirement ID. This allows a user or process to obtain the requirement data for a specified, section and requirement ID. It also allows, for example, a user to find all requirements of a specified type and assurance level. An assurance level, as is known in the art, is a level of assurance that stated security objectives will be met. A higher-level of assurance may put additional burden on those responsible for ensuring that security objectives are met, and may result in expanded security requirements, beyond those required for a lower level of assurance. The requirements Options Table 216 specifies for each Requirements ID one or more Option ID, and for each Option ID, a name and text description. Options described in this table are allowed methods for meeting a requirement. For any given requirement several options may exits. Some options may not completely fulfill the requirement by themselves and may require other specific options to also be selected. Such constraints are represented in the “Options Relations Include” table 212. Similarly some options may only fulfill a requirement if other specified options are not selected. These constraints are defined in the “Options Relations Exclude” table 218. The Step Definitions table 220 describes for each option the steps that are needed to be taken to fulfill the requirement. This table also may also associate with each option (as identified by the option ID) a step order, which indicates the order in which a step must be taken. Steps for a given option that have the same order value may be taken in any order. This table may also associate the step with a responsible person, a responsible role, a text description, or a Parsable token. The parsable token is a value such that various parts of the value may have inherent meaning. For example, HA.IssuingCA.PrivateKey.Protection.Physical.001 may be parsed to mean that this step is associated with a requirement for physically protecting the private key of an issuing CA operating at an assurance level known as High Assurance. These tables are provided as examples of those that may be contained in the PCRD 102. In a real world implementation many other tables would likely be used. For example, not shown are tables that may contain user IDs and privileges needed for accessing and updating other tables, tables used for logging events, time stamps and user IDs indicating information as to when and how other tables were modified. For implementations where one Policy Management Tool is used to manage the certificate policies of multiple organizations, additional tables may be needed that indicate which set of other tables are associated with a given organization, and which files hold organizational data for a given organization.

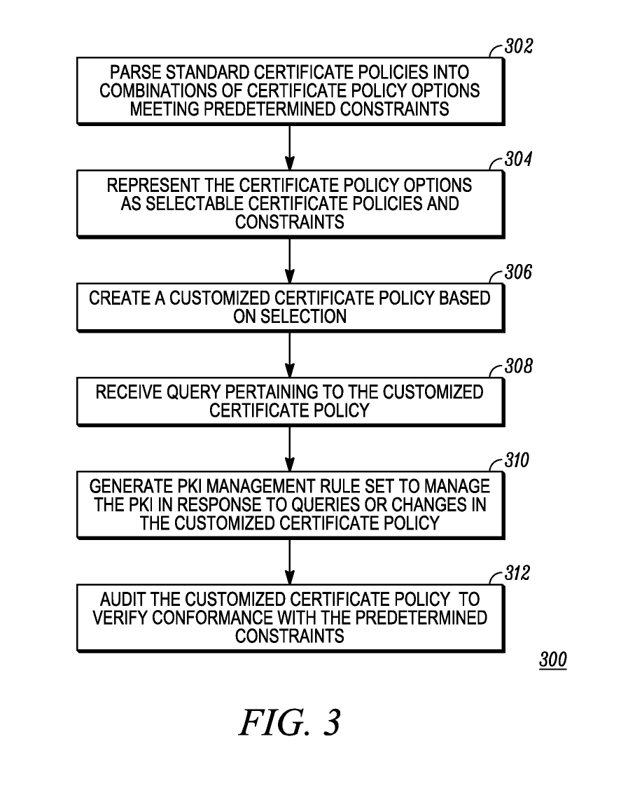

Referring to FIG. 3 there is shown a method 300 for managing certificate policies within a public key infrastructure (PKI) in accordance with the various embodiments. Method 300 begins at 302 with parsing standard certificate policies into combinations of certificate policy options meeting predetermined constraints. Step 302 can be accomplished, for example, by modifying a policy creation rule database (PCRD) schema based on the policy creation rule text files. At 304, the certificate policy options are represented as selectable certificate policy options and constraints. The constraints mentioned here are rules which constrain the selection of various policy options based on previously selected options. Step 304 can be accomplished, for example, by populating content from the policy creation rule text files into the (PCRD). A customized certificate policy (or policies) is then created at 306 based on selection of the selectable certificate policy options. A query (or queries) is received at 308 pertaining to the customized certificate policy. The queries are application level policy related queries pertaining to the customized certificate policy. One or more database queries may be generated based on the received queries. In response to the queries or changes in the customized certificate policy, a PKI Management rule set is generated at 310 which is used to manage the PKI. The PKI Management rule set can be generated for example, by retrieving the customized certificate policy data, creating a PKI Management rule set based on the retrieved certificate policy data, and mapping the PKI Management rule set into an application specific message. The customized certificate policy then is audited at 312 to verify conformance with the predetermined constraints. The step of auditing can be accomplished for example, by comparing the customized certificate policy to verify that it conforms to constraints set by the standard certificate policies. Furthermore, an audit report may be generated to indicate differences and incompatibilities between external organization certificates operational policies, standard certificate policies and the customized certificate policies.

Accordingly, there has been provided a policy management tool which allows policies to be defined by choosing from options specified in standard policies as opposed to starting from scratch. Storing the policies in a certificate policy database enables easy updates to these customized certificate policies. The use of a policy query engine to handle queries ensures that the customized certificate policies are enforced in a uniform manner using a centralized policy. The use of the certificate policy auditing engine tool provides a security measure by ensuring that the customized polices remain within organization specific constraints.

The policy management tool allows a specific organization, such as a public safety organization, to cost effectively operate and manage a highly secure PKI by simplifying the organization's PKI certificate policy creation and management. Customized certificate policies and the management of these policies can now be developed to assist a public safety organization to easily inter-operate with other organizations. Being able to compare the customized certificate polices with multiple organizations facilitates policy mapping, if required. The policy management tool operating in accordance with the various embodiments thus provides a distinctive advantage over previous PKI capability.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A certificate policy management tool suite, comprising:
a plurality of PKI management components including:
at least one processor comprising:
a certificate policy parser;
a certificate policy creation engine;
a certificate policy query engine;
an audit engine; and
wherein the certificate policy parser, the certificate policy creation engine, the certificate policy query engine, and the audit engine interoperate to automate certificate policy creation, interpretation, assessment, and enforcement.

2. The certificate policy management tool suite of claim 1, wherein the certificate policy creation is customized based on user input to the certificate policy creation engine.

3. The certificate policy management tool suite of claim 1, wherein the certificate policy parser reads in and parses standard certificate policies containing standard public safety options and constraints.

4. The certificate policy management tool suite of claim 3, wherein the certificate policy creation engine determines allowable combinations of certificate policy options based on the user inputs and constraints contained within the standard certificate policies thereby generating organization-specific operational certificate policies.

5. The certificate policy management tool suite of claim 4, wherein the certificate policy query engine generates a PKI management rule set in response to queries based on data obtained from the organization-specific operational certificate policies.

6. The certificate policy management tool suite of claim 4, wherein the certificate policy query engine generates a PKI management rule set in response to changes in the organization-specific operational certificate policies.

7. The certificate policy management tool suite of claim 1, wherein the audit engine compares first and second separate sets of certificate policies, and generates a report, identifying differences and incompatibilities.

8. The certificate policy management tool suite of claim 7, wherein the audit engine audits the certificate policy management tool to verify whether the first and second separate sets of certificate policies conform to each other.

9. The certificate policy management tool suite of claim 7, wherein the audit engine further generates rules that map the policies of the first certificate policy set to the policies of the second certificate policy set.

10. The certificate policy management tool suite of claim 7, wherein the first set of certificate policies comprises external organization operational policies, and the second set of certificate polices comprises parsed standard certificate policies.

11. The certificate policy management tool suite of claim 7, wherein the first set of certificate policies comprises external organization operational policies, and the second set of certificate polices comprises organization-specific operational certificate policies.

12. A method for managing certificate policies within a public key infrastructure (PKI): comprising:
parsing standard certificate policies into combinations of certificate policy options meeting predetermined constraints;
providing the certificate policy options as user selectable certificate policy options;
creating customized certificate policies based on user selection of the selectable certificate policy options;
generating a PKI management rule set with which to manage the PKI; and
auditing the customized certificate policy to verify conformance with the predetermined constraints set by the standard certificate policies.

13. The method of claim 12, wherein the steps of generating PKI management rule set is triggered by receiving a certificate policy query pertaining to the customized certificate policy or changes to the customized certificate policy.

14. The method of claim 12, wherein the step of parsing standard certificate policies into combinations of certificate policy options meeting predetermined constraints comprises parsing a set of standard certificate policy creation rule text files.

15. The method of claim 14, wherein the step of parsing standard certificate policies into combinations of certificate policy options meeting predetermined constraints further comprises: modifying a policy creation rule database (PCRD) schema based on the policy creation rule text files.

16. The method of claim 14, wherein the step of providing the certificate policy options as user selectable certificate policy options comprises:
populating content from the policy creation rule text files into the (PCRD).

17. The method of claim 13, wherein the step of receiving a query pertaining to the customized certificate policy, comprises:
receiving application level policy related queries pertaining to the customized certificate policy; and
generating one or more database queries based on the received queries.

18. The method of claim 12, wherein the step of generating a rule set with which to manage the PKI, comprises:
retrieving certificate policy data from the customized certificate policy;
creating a rule set based on the retrieved certificate policy data; and
mapping the rule set into an application specific message.

19. The method of claim 12, wherein the step of auditing further comprises:
generating an audit report indicating differences between external organization certificates operational policies, standard certificate policies and the customized certificate policies.

20. A certificate policy management tool suite having at least one processor operating to:
create a certificate policy by:
reading, by a certificate policy creation engine, a current set of certificate policy options from a certificate policy creation rules database (PCRD), the certificate policy engine and PCRD being used to manage a public key infrastructure (PKI);
providing the current set of certificate options to a user;
accepting user input in response to the current set of options;
mapping user input to appropriate certificate policy options;
storing the mapped certificate policy options;
forming a next set of certificate policy options based on the user input and constraints defined in the PCRD; and
iteratively repeating providing, accepting, mapping, storing, and forming until an acceptable set of options are formed thereby generating a customized certificate policy.

21. The certificate policy management tool suite having the at least one processor of claim 20, further operating to:
receive, at a policy query engine, application level certificate policy related queries pertaining to the customized certificate policy from other PKI components within the PKI;
generate one or more database queries based on the received queries;
retrieve certificate policy data from operational policy database in response to the one or more database queries;
create a rule set based on the retrieved data and the requesting PM components; and
map the rule set into an application specific response.

22. The certificate policy management tool suite having the at least one processor of claim 21, further operating to:
detect, at a policy query engine, changes to the customized certificate policy;
retrieve certificate policy data from the operational policy database;
create a rule set based on the retrieved certificate policy data and the requesting PKI components; and
map the rule set into an application specific message.

23. The certificate policy management tool suite having the at least one processor of claim 21, wherein the application level policy related queries contain requests for PKI policy configuration data.

24. The certificate policy management tool suite having the at least one processor of claim 21, wherein the application level policy related queries contain requests for certificate lifecycle management (CLM) operation approval.

25. The certificate policy management tool suite having the at least one processor of claim 20, further operating to:
create the current set of certificate policy options by:
parsing a set of standard certificate policy creation rule text files;
modifying the PCRD database schema based on the certificate policy creation rule text file;
populating the content of these files into the certificate policy creation rule database (PCRD); and
creating metadata, defining a new schema which can be used by other PKI components.

26. The certificate policy management tool suite having the at least one processor of claim 20, wherein the customized certificate policy comprises an organization-specific operational certificate policy.
